(19) United States
(12) Patent Application Publication
(10) Pub. No.: US 2009/0120093 A1
(43) Pub. Date: May 14, 2009

(54) Turbulated aft-end liner assembly and cooling method

(75) Inventors: Thomas Edward Johnson, Greer, SC (US); Patrick Melton, Horse Shoe, NC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/905,238

(22) Filed: Sep. 28, 2007

(51) Int. Cl. F02C 7/12; F23R 3/42; F02C 7/20

(52) U.S. Cl. 60/752; 60/796; 60/772

(57) ABSTRACT

In a combustor for a turbine a cover sleeve is disposed between the aft end portion of the combustor liner and a resilient seal structure to define an air flow passage therebetween. The cover sleeve has at a forward end thereof a plurality of air inlet feed holes for directing cooling air into the air flow passage. A radially outer surface of the combustor liner aft end portion defining the air flow passage includes a plurality of turbulators projecting towards but spaced from the cover sleeve and a plurality of supports extending to and engaging the cover sleeve to space the cover sleeve from the turbulators to define the air flow passage.

### BACKGROUND OF THE INVENTION

This invention relates to internal cooling within a gas turbine engine; and more particularly, to an assembly and method for providing better and more uniform cooling in a transition region between a combustion section and discharge section of the turbine.

Traditional gas turbine combustors use diffusion (i.e., non-premixed) combustion in which fuel and air enter the combustion chamber separately. The process of mixing and burning produces very high flame temperatures. Since conventional combustors and/or transition pieces having liners are not able to withstand such high temperatures, steps must be taken to protect the combustor and/or transition piece. This has typically been done by film-cooling which involves introducing relatively cool compressor air into a plenum formed by the combustor liner surrounding the outside of the combustor. In this prior arrangement, the air from the plenum passes through louvers in the combustor liner and then passes as a film over the inner surface of the liner, thereby maintaining combustor liner integrity.

Because diatomic nitrogen rapidly disassociates at temperatures exceeding about 3000° F. (about 1650° C.), the high temperatures of diffusion combustion result in relatively large NOx emissions. One approach to reducing NOx emissions has been to premix the maximum possible amount of compressor air with fuel. The resulting lean premixed combustion produces cooler flame temperatures and thus lower NOx emissions. Although lean premixed combustion is cooler than diffusion combustion, the flame temperature is still too hot for prior conventional combustor components to withstand.

Furthermore, because the advanced combustors premix the maximum possible amount of air with the fuel for NOx reduction, little or no cooling air is available, making film-cooling of the combustor liner and transition piece premature at best. Nevertheless, combustor liners require active cooling to maintain material temperatures below limits. In dry low NOx (DLN) emission systems, this cooling can only be supplied as cold side convection. Such cooling must be performed within the requirements of thermal gradients and pressure loss. Thus, means such as thermal barrier coatings in conjunction with “backside” cooling have been considered to protect the combustor liner and transition piece from destruction by such high heat. Backside cooling involved passing the compressor discharge air over the outer surface of the transition piece and combustor liner prior to premixing the air with the fuel.

With respect to the combustor liner, one current practice is to impingement cool the liner, or to provide turbulators on the exterior surface of the liner (see U.S. Pat. No. 7,010,921). Another practice is to provide an array of concavities on the exterior or outside surface of the liner (see U.S. Pat. No. 6,098,397). The various known techniques enhance heat transfer but with varying effects on thermal gradients and pressure losses. Turbulation works by providing a blunt body in the flow which disrupts the flow creating shear layers and high turbulence to enhance heat transfer on the surface. Dimple concavities function by providing organized vortices that enhance flow mixing and scrub the surface to improve heat transfer.

### BRIEF DESCRIPTION OF THE INVENTION

The above discussed and other drawbacks and deficiencies are overcome or alleviated in an example embodiment by an apparatus for cooling a combustor liner and transitions piece of a gas turbine.

Thus, the invention may be embodied in a combustor for a turbine comprising: a combustor liner; a first flow sleeve surrounding said combustor liner with a first flow annulus therebetween, said first flow sleeve having a plurality of cooling apertures formed about a circumference thereof for directing compressor discharge air as cooling air into said first flow annulus; a transition piece body connected to said combustor liner, said transition piece body being adapted to carry hot combustion gases to the turbine; a second flow sleeve surrounding said transition piece body, said second flow sleeve having a second plurality of cooling apertures for directing compressor discharge air as cooling air into a second flow annulus between the second flow sleeve and the transition piece body, said first flow annulus connecting to said second flow annulus; a resilient seal structure disposed radially between an aft end portion of said combustor liner and a forward end portion of said transition piece body; and a cover sleeve disposed between said aft end portion of said combustor liner and said resilient seal structure, an air flow passage being defined between said cover sleeve and said aft end portion of said combustor liner, a radially outer surface of said combustor liner aft end portion defining said air flow passage including a plurality of turbulators projecting towards but spaced from said cover sleeve and a plurality of supports extending to and engaging said cover sleeve to space said cover sleeve from said turbulators to define said air flow passage.

The invention may also be embodied in a turbine engine comprising: a combustion section; an air discharge section downstream of the combustion section; a transition region between the combustion and air discharge sections; a combustor liner defining a portion of the combustion section and transition region; a first flow sleeve surrounding said combustor liner with a first flow annulus therebetween, said first flow sleeve having a plurality of rows of cooling apertures formed about a circumference of said first flow sleeve for directing compressor discharge air as cooling air into said first flow annulus; a transition piece body connected to at least one of said combustor liner and said first flow sleeve, said transition piece body being adapted to carry hot combustion gases to a stage of the turbine corresponding to the air discharge section; a second flow sleeve surrounding said transition piece body, said second flow sleeve having a second plurality of rows of cooling apertures for directing compressor discharge air as cooling air into a second flow annulus between the second flow sleeve and the transition piece body, said first flow annulus connecting to said second flow annulus; a resilient seal structure disposed radially between an aft end portion of said combustor liner and a forward end portion of said transition piece body; and a cover sleeve disposed between said aft end portion of said combustor liner and said resilient seal structure, an air flow passage being defined between said cover sleeve and said aft end portion of said combustor liner, a radially outer surface of said combustor liner aft end portion defining said air flow passage including a plurality of turbulators projecting towards but spaced from said cover sleeve and a plurality of supports extending to and engaging said cover sleeve to space said cover sleeve from said turbulators to define said air flow passage.

The invention may also be embodied in a method of cooling a transition region between a combustion section comprising a combustor liner and a first flow sleeve surrounding said combustor liner with a first flow annulus therebetween, said first flow sleeve having a plurality of cooling apertures formed about a circumference thereof for directing compressor discharge air as cooling air into said first flow annulus, and a transition region comprising a transition piece body connected to said combustor liner, said transition piece body being adapted to carry hot combustion gases to a turbine, a second flow sleeve surrounding said transition piece body, said second flow sleeve having a second plurality of cooling apertures for directing compressor discharge air as cooling air into a second flow annulus between the second flow sleeve and the transition piece body, said first flow annulus connecting to said second flow annulus; said transition region including a resilient seal structure disposed radially between an aft end portion of said combustor liner and a forward end portion of said transition piece body; the method comprising: configuring said aft end portion of said combustor liner so that a radially outer surface thereof includes a plurality of radially outwardly projecting turbulators and a plurality of radially outwardly projecting supports having a radial height greater than that of said turbulators; disposing a cover sleeve between said aft end portion of said combustor liner and said resilient seal structure to define an air flow passage between said cover sleeve and said aft end portion of said combustor liner, said turbulators projecting towards but being spaced from said cover sleeve and said supports extending to and spacing said cover sleeve from said turbulators to define said air flow passage; and supplying compressor discharge air to and through said air inlet feed holes and through said air flow passage to reduce a temperature in a vicinity of said resilient seal.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a partial schematic illustration of a gas turbine combustor section;

FIG. 2 is a partial but more detailed perspective of a conventional combustor liner and flow sleeve joined to the transition piece;

FIG. 3 is an exploded partial view of the aft end of a conventional combustion liner;

FIG. 4 is an elevational view of a prior art aft liner region;

FIG. 5 is a schematic elevational view of an aft liner region embodying the invention;

FIG. 6 is a schematic end view of the aft liner region of FIG. 5; and

FIG. 7 is an enlarged schematic elevation showing the detail of the encircled portion of FIG. 5.

### DETAILED DESCRIPTION OF THE INVENTION

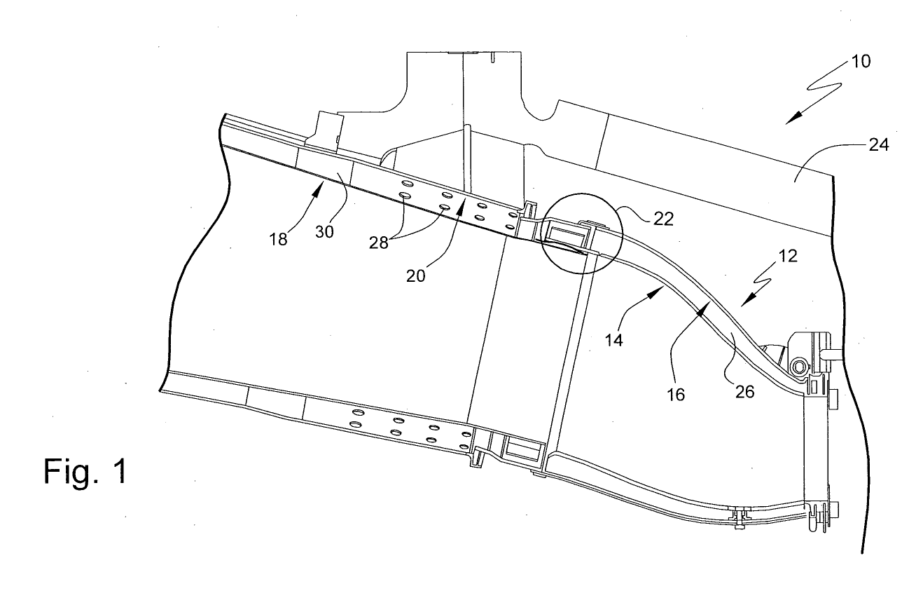

FIG. 1 schematically depicts the aft end of a combustor in cross-section. As can be seen, in this example, the transition piece 12 includes a radially inner transition piece body 14 and a radially outer transition piece impingement sleeve 16 spaced from the transition piece body 14. Upstream thereof is the combustion liner 18 and the combustor flow sleeve 20 defined in surrounding relation thereto. The encircled region is the transition piece forward sleeve assembly 22.

Flow from the gas turbine compressor (not shown) enters into a case 24. In one example embodiment, about 50% of the compressor discharge air passes through apertures (not shown in detail) formed along and about the transition piece impingement sleeve 16 for flow in an annular region or annulus 26 between the transition piece body 14 and the radially outer transition piece impingement sleeve 16. The remainder of the compressor discharge flow, approximately 50% in this example, passes into flow sleeve holes 28 of the upstream combustion liner flow sleeve 20 and into an annulus 30 between the flow sleeve 20 and the liner 18 and mixes with the air from the downstream annulus 26. The combined air eventually mixes with the gas turbine fuel in the combustion chamber. Although a 50-50 flow split is mentioned herein above, it is to be understood that other flow split, or even 100% transition piece flow could be adopted in stead.

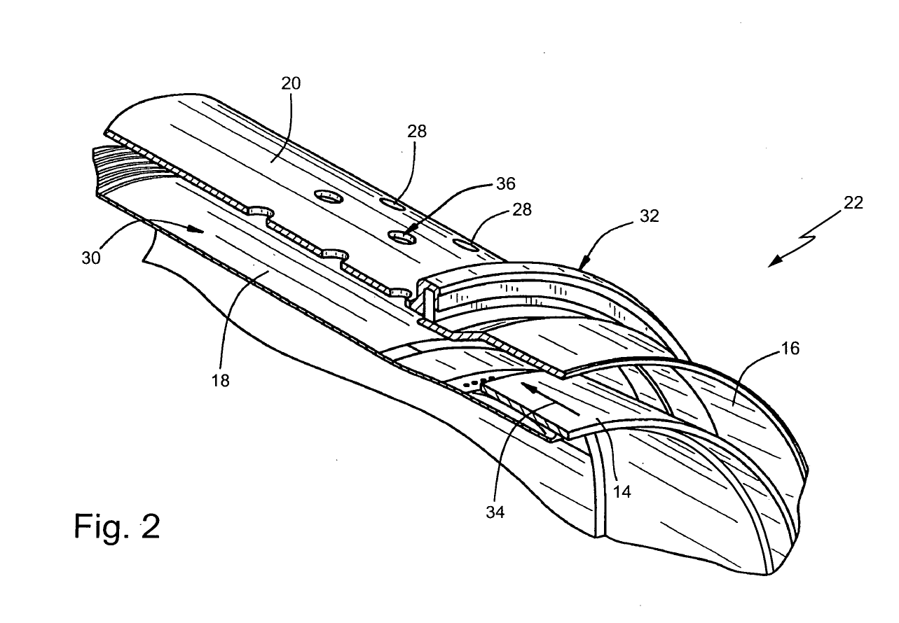

FIG. 2 illustrates the connection at 22 between the transition piece 14,16 and the combustor liner and flow sleeve 18,20. Specifically, the impingement sleeve 16 (or second flow sleeve) of the transition piece 14 is received in telescoping relationship in a mounting flange 32 on the aft end of the combustor flow sleeve 20 (or first flow sleeve). The transition piece 14 also receives the combustor liner 18 in a telescoping relationship. The combustor flow sleeve 20 surrounds the combustor liner 18 creating flow annulus 30 (or first flow annulus) therebetween. It can be seen from the flow arrow 34 in FIG. 2, that crossflow cooling air traveling in annulus 26 continues to flow into annulus 30 in a direction perpendicular to impingement cooling air flowing through the cooling holes 28 (see flow arrow 36) formed about the circumference of the flow sleeve 20 (while three rows are shown in FIG. 2, the flow sleeve may have any number of rows of such holes).

Still referring to FIGS. 1 and 2, a typical can annular reverse-flow combustor is shown for a turbine that is driven by the combustion gases from a fuel where a flowing medium with a high energy content, i.e., the combustion gases, produces a rotary motion as a result of being deflected by rings of blading mounted on a rotor. In operation, discharge air from the compressor (compressed to a pressure on the order of about 250-400 lb/in²) reverses direction as it passes over the outside of the combustor liners (one shown at 18) and again as it enters the combustor liner 18 en route to the turbine. Compressed air and fuel are burned in the combustion chamber, producing gases with a temperature of about 2800° F. These combustion gases flow at a high velocity into turbine section via transition piece 14.

There is a transition region indicated generally at 22 in FIG. 1 between the combustion section and the transition piece. As previously noted, the hot gas temperature at the aft end of section 18, the inlet portion of region 22, is on the order of about 2800° F. However, the liner metal temperature at the downstream, outlet portion of region 22 is preferably on the order of 1400-1550° F. To help cool the liner to this lower metal temperature range, during passage of heated gases through region 22, the aft end 50 of the liner defines passage(s) through which cooling air is flowed. The cooling air serves to draw off heat from the liner and thereby significantly lower the liner metal temperature relative to that of the hot gases.

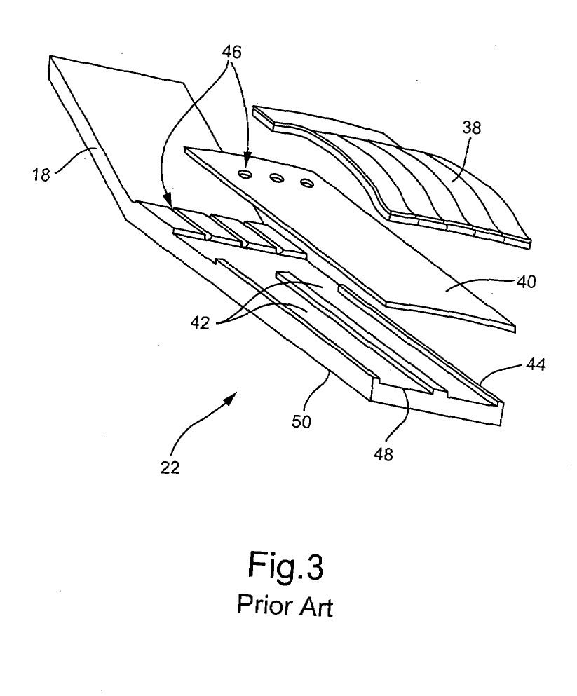

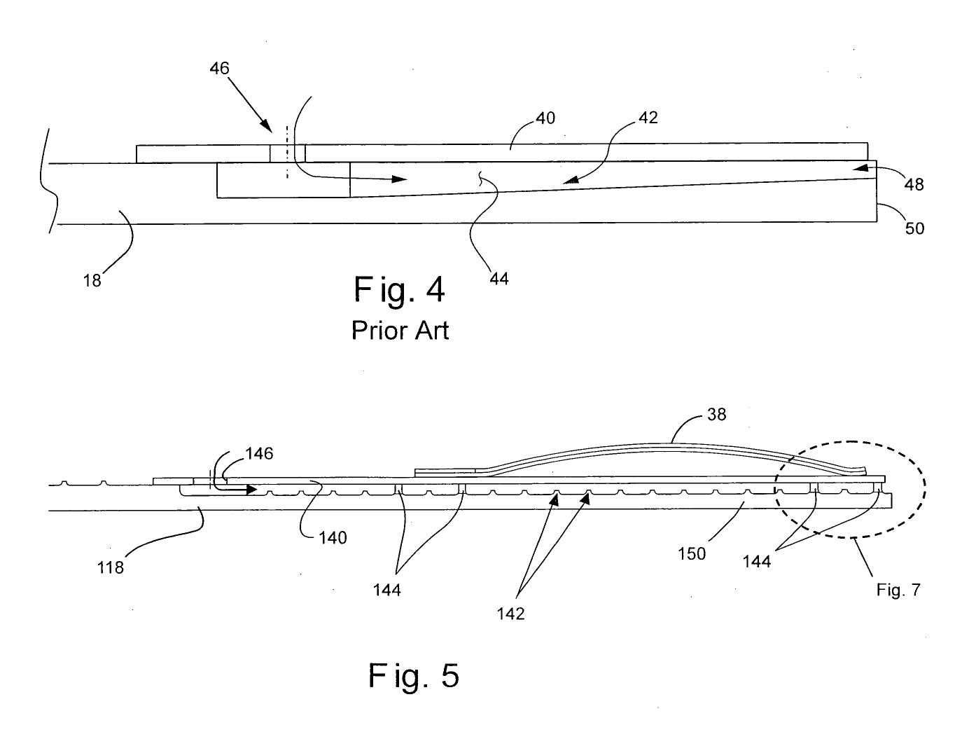

Referring to FIG. 3, liner 18 has an associated compression-type seal 38, commonly referred to as a hula seal, mounted between a cover plate 40 of the liner aft end 50, and transition piece 14. More specifically, the cover plate 40 is mounted on the liner aft end 50 to form a mounting surface for the compression seal. As shown in FIG. 3, liner 18 has a plurality of axial channels 42 formed with a plurality of axial raised sections or ribs 44 all of which extend over a portion of aft end 50 of the liner 18. The cover plate 40 and ribs 44 together define the respective airflow channels 42. These channels are parallel channels extending over a portion of the aft end of liner 18. Cooling air is introduced into the channels through air inlet slots and/or openings 46 at the forward end of the channels. The air then flows into and through the channels 42 and exits the liner through openings 48. As shown in FIG. 4, the cross-section of the channel as defined by its height may decrease along the length of the channel in an aft direction.

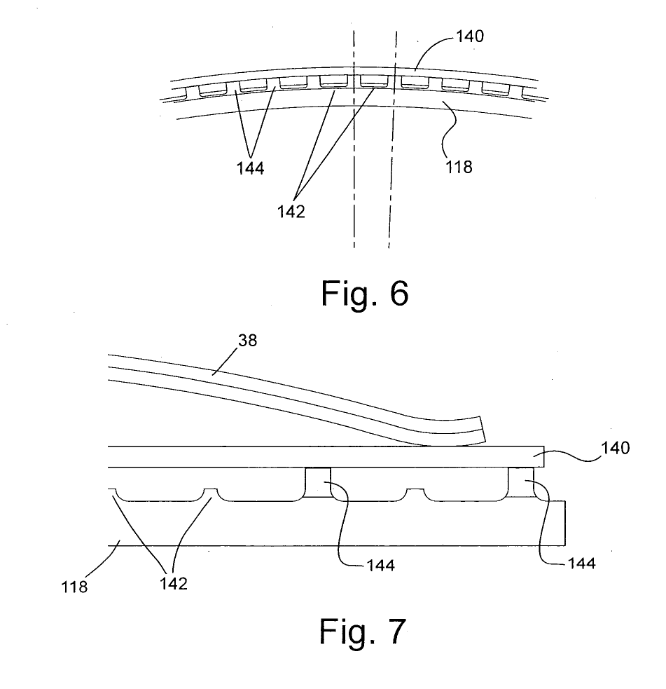

As noted, the invention pertains to the design of a combustion liner used in a gas turbine engine and more specifically the cooled aft-end of the combustion liner as an improvement to the conventional structure shown in FIG. 4. As noted above, this area has conventionally been composed of axial grooves 42 machined into the liner 18 and a sheet metal cover 40 that is used to support the aft-end Hula seal 38. According to an example embodiment of the invention, rather than providing axial grooves 42 as in the conventional combustion liner, an annular cooling system is provided that features transverse turbulators 142 as illustrated in FIGS. 5-7. Thus, as illustrated in FIG. 5, a sheet metal cover 140 is provided to support the aft-end Hula seal 38 and defines an air passage with the liner aft-end 150. The sheet metal cover includes air inlet feed holes 146 for passage of cooling media to the region below the Hula seal 38. In addition or in the alternative, air inlet slots as illustrated in FIG. 3 may be provided. Spaced supports 144 are provided at the forward and aft ends of the Hula seal 38 to maintain the sheet metal cover 140 spaced from the liner aft-end 150. As illustrated in FIG. 6, the supports 144 are circumferentially spaced from one another about the axis of the combustor liner so that in the illustrated embodiment, four axially spaced rows of supports are provided (FIG. 5), each row comprised of a plurality of circumferentially spaced supports (FIG. 6). Advantages of the illustrated design are many in comparison with the conventional design of FIG. 4 and include better heat transfer per unit air used, easier production than axial grooves from a machine/manufacturing standpoint; lower heat input to the temperature limited Hula seal; and an ability to achieve a lower temperature in the liner's aft end which would be critical in engines with higher firing temperatures.

The transverse turbulators 142 provided according to an example embodiment of the invention are a highly effective heat transfer augmentation device. It is common to see heat transfer numbers significantly better than non-turbulated sections with the same quantity of cooling air. Therefore, by providing transverse turbulators as proposed herein, it is possible to achieve the same amount of heat transfer as in the conventional structure with less cooling air. This would be a highly desirable feature in lean pre-mixed gas turbines because the cooling air can be used more effectively in other parts of the system. The transverse turbulators are expected to be more manufacturing friendly than the conventional axial channels because, in particular they are less sensitive to small variations in the manufacturing process then channeled flow.

As noted above, among current cooing systems are those composed of numerous axially extending cooling channels. These channels 42 are defined by walls that extend radially outward from the hot side of the liner aft end 50 to the sheet metal cover 40, as shown in FIG. 4. The cover 40 makes contact with and is supported by the top of the channel defining walls 44 (see U.S. Pat. No. 7,010,921). A significant amount of heat transfer flows through this assembly and into the Hula seal 38 that sits on top of the sheet metal cover 40. The Hula seal's function is to act like a spring while maintaining a good seal. This part has a limited temperature capability and is often very close to its functional limit. The configuration proposed herein (FIGS. 5-7) helps limit the heat transfer to the Hula seal by significantly reducing the contact area through which the heat can flow into the seal by limiting that contact area to the spaced supports 144.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A combustor for a turbine comprising:
a combustor liner;
a first flow sleeve surrounding said combustor liner with a first flow annulus therebetween, said first flow sleeve having a plurality of cooling apertures formed about a circumference thereof for directing compressor discharge air as cooling air into said first flow annulus;
a transition piece body connected to said combustor liner, said transition piece body being adapted to carry hot combustion gases to the turbine;
a second flow sleeve surrounding said transition piece body, said second flow sleeve having a second plurality of cooling apertures for directing compressor discharge air as cooling air into a second flow annulus between the second flow sleeve and the transition piece body, said first flow annulus connecting to said second flow annulus;
a resilient seal structure disposed radially between an aft end portion of said combustor liner and a forward end portion of said transition piece body; and
a cover sleeve disposed between said aft end portion of said combustor liner and said resilient seal structure, an air flow passage being defined between said cover sleeve and said aft end portion of said combustor liner, a radially outer surface of said combustor liner aft end portion defining said air flow passage including a plurality of turbulators projecting towards but spaced from said cover sleeve and a plurality of supports extending to and engaging said cover sleeve to space said cover sleeve from said turbulators to define said air flow passage.

2. The combustor of claim 1, wherein said supports are disposed substantially to underlie a forward end and an aft end of said resilient seal structure.

3. The combustor of claim 1, wherein said resilient seal structure is a Hula seal.

4. The combustor of claim 1, wherein a plurality of axially spaced rows of supports are provided, each said row of supports including a plurality of circumferentially spaced supports.

5. The combustor of claim 1, wherein said first plurality of cooling apertures are configured with an effective area to distribute about 50% of the compressor discharge air to said first flow annulus.

6. The combustor of claim 1, wherein said cover sleeve has at a forward end thereof a plurality of air inlet feed holes for directing cooling air from said first annulus into said air flow passage.

7. A turbine engine comprising:
a combustion section;
an air discharge section downstream of the combustion section;
a transition region between the combustion and air discharge sections;
a combustor liner defining a portion of the combustion section and transition region;
a first flow sleeve surrounding said combustor liner with a first flow annulus therebetween, said first flow sleeve having a plurality of rows of cooling apertures formed about a circumference of said first flow sleeve for directing compressor discharge air as cooling air into said first flow annulus;
a transition piece body connected to at least one of said combustor liner and said first flow sleeve, said transition piece body being adapted to carry hot combustion gases to a stage of the turbine corresponding to the air discharge section;
a second flow sleeve surrounding said transition piece body, said second flow sleeve having a second plurality of rows of cooling apertures for directing compressor discharge air as cooling air into a second flow annulus between the second flow sleeve and the transition piece body, said first flow annulus connecting to said second flow annulus;
a resilient seal structure disposed radially between an aft end portion of said combustor liner and a forward end portion of said transition piece body; and
a cover sleeve disposed between said aft end portion of said combustor liner and said resilient seal structure, an air flow passage being defined between said cover sleeve and said aft end portion of said combustor liner, a radially outer surface of said combustor liner aft end portion defining said air flow passage including a plurality of turbulators projecting towards but spaced from said cover sleeve and a plurality of supports extending to and engaging said cover sleeve to space said cover sleeve from said turbulators to define said air flow passage.

8. A turbine engine as in claim 7, wherein said first plurality of cooling apertures configured with an effective area to distribute about 50% of the compressor discharge air to said first flow annulus.

9. A turbine engine as in claim 7, wherein said supports are disposed substantially to underlie a forward end and an aft end of said resilient seal structure.

10. A turbine engine as in claim 7, wherein said resilient seal structure is a Hula seal.

11. A turbine engine as in claim 7, wherein a plurality of axially spaced rows of supports are provided, each said row of supports including a plurality of circumferentially spaced supports.

12. A turbine engine as in claim 7, wherein said cover sleeve has at a forward end thereof a plurality of air inlet feed holes for directing cooling air from said first annulus into said air flow passage.

13. A method of cooling a transition region between a combustion section comprising a combustor liner and a first flow sleeve surrounding said combustor liner with a first flow annulus therebetween, said first flow sleeve having a plurality of cooling apertures formed about a circumference thereof for directing compressor discharge air as cooling air into said first flow annulus, and a transition region comprising a transition piece body connected to said combustor liner, said transition piece body being adapted to carry hot combustion gases to a turbine, a second flow sleeve surrounding said transition piece body, said second flow sleeve having a second plurality of cooling apertures for directing compressor discharge air as cooling air into a second flow annulus between the second flow sleeve and the transition piece body, said first flow annulus connecting to said second flow annulus; said transition region including a resilient seal structure disposed radially between an aft end portion of said combustor liner and a forward end portion of said transition piece body;
the method comprising:
configuring said aft end portion of said combustor liner so that a radially outer surface thereof includes a plurality of radially outwardly projecting turbulators and a plurality of radially outwardly projecting supports having a radial height greater than that of said turbulators;
disposing a cover sleeve between said aft end portion of said combustor liner and said resilient seal structure to define an air flow passage between said cover sleeve and said aft end portion of said combustor liner, said turbulators projecting towards but being spaced from said cover sleeve and said supports extending to and spacing said cover sleeve from said turbulators to define said air flow passage; and
supplying compressor discharge air to and through said air flow passage to reduce a temperature in a vicinity of said resilient seal.

14. A method as in claim 13, wherein said first plurality of cooling apertures configured with an effective area to distribute about 50% of the compressor discharge air to said first flow annulus.

15. A method as in claim 13, wherein said supports are disposed substantially to underlie a forward end and an aft end of said resilient seal structure.

16. A method as in claim 13, wherein said resilient seal structure is a Hula seal.

17. A method as in claim 13, wherein a plurality of axially spaced row of supports are provided, each said row of supports including a plurality of circumferentially spaced supports.

18. A method as in claim 13, wherein said cover sleeve has at a forward end thereof a plurality of air inlet feed holes for directing cooling air from said first annulus into said cooling air passage, and wherein said supplying compressor discharge air comprises supplying compressor discharge air to and through said air inlet feed holes to said air flow passage.
